(19) United States
(12) Patent Application Publication
(10) Pub. No.: US 2008/0068180 A1
(43) Pub. Date: Mar. 20, 2008

(54) Radio frequency identification tag embedded in the windshields of vehicle for wirelessly determining vehicle identification, location and toll collection

(76) Inventors: Steven W. Powell, Memphis, TN (US); Douglas M. Williams, Memphis, TN (US)

Correspondence Address: Ortiz and Lopez, PLLC, P.O. Box 4484, Albuquerque, NM, 87196-4484, US

(21) Appl. No.: 11/518,578

(22) Filed: Sep. 11, 2006

(51) Int. Cl. G08B 13/14; G05B 19/00; G06F 17/00; B60Q 1/00; G08G 1/123

(52) U.S. Cl. 340/572.8; 340/425.5; 340/988; 235/375; 340/5.8

(57) ABSTRACT

A system enables collection of data using a radar challenging units familiar in RF tagging system in communication with RFid tags embedded in windshields associated with motor vehicles. The edge of a windshield is fabricated with a slot either before or during the manufacturing of the windshield. The slot is usable to accept an RFid tag and associated electronics. Once electronics are installed in the slot it can be sealed for tamper resistance and weather protection. Wiring providing power and data transfer to the RF tags can be routed from the edge of the windshield through rubber sealing surrounding the windshield and car frame, and be routed into internal compartments of the vehicle for applications where data/computer integration is desired. Collectable data includes: VIN, registration status, inspection status, insurance status, Amber alert, licensing information and others.

### INVENTION PRIORITY

The present invention claims priority to provisional patent application Ser. No. 60/715,251 filed Sep. 7, 2005 by co-inventors Steven W. Powell and Douglas M. Williams, both residents of Memphis, Tennessee.

### FIELD OF THE INVENTION

The present invention is related to: embedding the RFid electronic components of the tag inside the window windshield (front, rear and or side) as part of the windshield manufacturing process, to manage the vehicle identification numbers (VIN), motor vehicle registrations, motor vehicle inspections, insurance compliance, Amber Alert, emission compliance, speed monitoring, handheld & mobile radar detection, Toll booth dollar amounts, Global positioning system (GPS) integration, location determination, motor vehicle security/retrieval, and radar initiated challenge/response of RFid components embedded in the window.

### BACKGROUND

Many city and state governments are currently burdened financially. The present inventors believe that public revenue generation can improve with the addition of radar tracking over the Registration expiration date (ex. August 2007), inspection expiration date, insurance expiration date, and more.

For many years' the RFid tag (toll tag, et al) was designed as a separate unit that had to be attached to the vehicle via tape adhesive or attached to the vehicle interior or exterior as a snap on unit.

The use of radio frequency tagging (RFid tagging) has not apparently advanced to the point that the RFid tag is physically “embedded” into the actual windshield(s) of the vehicle. This present invention provides that RFid tag components can be embedded in the windshield(s) of the vehicle as a standard permanent fixture.

### SUMMARY OF THE INVENTION

The invention includes the a process of physical embedding of the RFid tag components into the windshield(s) of the vehicle as a permanent fixture for methods and systems in determining the identification number (VIN), compliance status (e.g., registration, inspection, Amber Alerts, emissions, location (e.g., GPS), and speed of a motor vehicle, all without police intervention via the RFid circuitries unique identification number.

In accordance with a feature of the present invention, an RFid unit in the windshield can be embedded together with a vehicle's information or other relevant information for local, state and federal agencies. Through Database access and management, many different forms of data can be immediately retrieved for instant use by law enforcement agencies. In accordance with features of the present invention, the RFid unit can receive challenges from a transceiver radio unit, and return data in response to the challenge via the RFid Transponder tag.

In accordance with a method of the present invention, a “Challenger” transmits a radio frequency signal to a moving vehicle also equipped with at least one transponder (RFid unit in embedded in the windshield), referred to as the “transponder.” The challenger functionality can be included in or associated with a police radar gun so that data (e.g., VIN, registration, compliance) is also provided to the challenger together with vehicle speed info.

In accordance with another feature of the present invention, the Challenger functionality can also be integrated with tollbooth equipment, or can be deployed throughout communities at various intersections, interstates, highways, airport garage entrance/exits, federal & state building garages, bridges, overpasses, etc.

With system architecture in accordance with features of the present invention, the Transponder can include the unique identification number (e.g., hexadecimal number), this number references the database to provide the VIN, license plate, owner name, make of vehicle, insurance compliance, etc.

In accordance with yet another feature of the present invention, additional RF units can be deployed throughout a vehicle with status and reporting coordinated by, with or through the main transponder embedded components in the windshield.

In accordance with a feature of the present invention, a CPU can assist with transponder coordination. Modern motor vehicles include a CPU (computer board and circuitry) within the engine block. An RF tag can also be integrated with the engine CPU or can coordinate with the engine computer. Use of several tags, including the VIN plate and engine tags can ensure that a motor vehicle's identity is preserved. Thieves will not likely be able to disable vehicle identify capabilities where several, hard to reach, tag components are used. All tag unit components can be operable as the Transponder.

In accordance with another feature of the present invention, a motor vehicle can be disabled based on at least one of: vehicle location, security status (e.g., theft indicated), or intervention by the owner, lien holder or a third party on the owner's/line holder's behalf. Smart disablement means that a motor vehicle will be directed to stall (cease operation) when it is determined (either by third party resources/services, or preprogrammed network equipment associated with a service) that the vehicle is in a safe mode (e.g., less than 5 MPH) or location (e.g., out of heavy traffic or congested areas).

In accordance with another feature of the present invention, distributed tagging can be used to provide operational readiness/status/feedback to main computer assets in a motor vehicle. Vehicle-based tag communications can operate using the Bluetooth standard or other RF protocols.

### BRIEF DESCRIPTION OF THE DRAWINGS

FIG. 1 illustrates the system architecture of the RFid slot in the manufacturing of the windshield(s) and its unique features can be deployed.

FIG. 2 illustrates a vehicle windshield incorporating RFid tagging technology built into the vehicle windshield(s).

FIG. 3 also shows the RFid Transponder card/tag unit internal circuitry and the unique features that can be deployed.

### DETAILED DESCRIPTION OF THE INVENTION

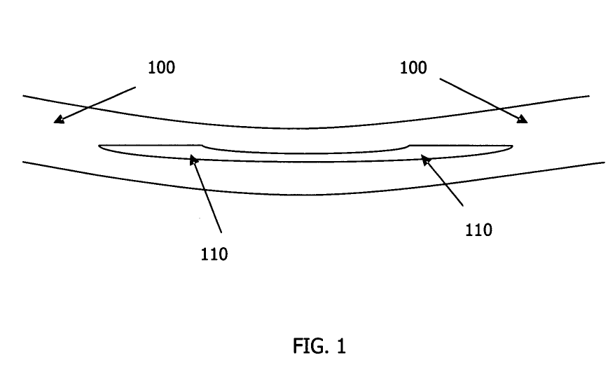

Referring to FIG. 1, illustrated is an edge view of a windshield 100 wherein a slot 110 is developed along the edge of a windshield 100 during the manufacturing of the windshield. The slot can be created during windshield manufacturing or routed after a windshield is manufactured. The slot 110 is usable to accept an RFid tag (not shown) and associated electronics. Once electronics are installed in the slot 110, the slot and electronics can be sealed for tamper resistance and weather protection. Sealants known in the art, such a clear epoxy used for windshield repairs, can be selected to create a transparent encasement. A slot of up to about ⅛ inches in thickness, up to three inches long and about two inches deep could likely accommodate currently available RF tags. Wiring providing power and data transfer to the RF tags can be routed from the edge of the windshield through rubber sealing surrounding the windshield and car frame, and be routed into internal compartments of the vehicle for applications where data/computer integration is desired.

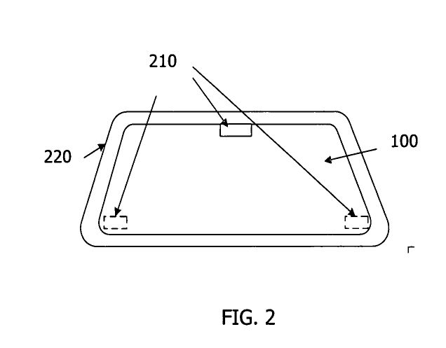

FIG. 2 illustrates a representation of a vehicle windshield 100 incorporating RFid tagging technology 210 built into the vehicle windshield at optional, various slot 110 locations along the edge of the windshield. It can be appreciated given this disclosure that the windshield can include front, back, side and top areas of glass on a motor vehicle.

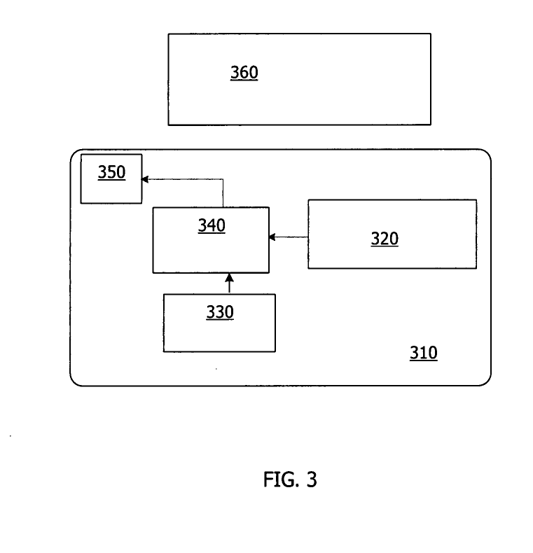

Referring to FIG. 3, illustrated is a windshield embedded RFid tag system necessary for operation. The RFid Tag 310 embedded into the slot located along an edge of a windshield can include a power source 320, unique identification module 330, and transceiver module 340. The power source can be battery, solar, or radar responsive, basically all methods of power supply known in the art in association with RF Tag operation. An LED indicator light 350 can also be incorporated into the RFid tag circuitry for operational and tampering indications. During operation, a remote challenging unit 360.

The following is a partial list of activities/users that can benefit from the present invention:
State Trooper Agencies
City Law Enforcement Agencies
Vehicle Insurance Agencies
Amber Alert
Homeland Security
Inter-country Tracking
Auto/Truck Rental Agencies
Parole/Probation Companies
Businesses involved with Intra/Inter-state transportation of goods or services
Repossession/Collection Companies

The RF tagging system can be used with radar systems, such as those used at toll centers. Police radar challengers can also be used. The capabilities of collecting the following data from a toll-booth-type- or hand-held radar-gun pointed at the vehicle include: VIN, registration expiration, inspection expiration, insurance expiration, Amber alert status, Tag information and additional features are particularly unique features enjoyed by agencies and customers.

There are two aspects to the Radar Data Pack design process: the physical design of the retro fit to the existing windshields, and the design of prefabricated windshields to accommodate RF tags. The aim is to offer a fast, easy to follow, quick to implement and effective way of delivering the information required to effect a successful operation. The unit will be designed in accordance with the individual application and the profile of the user in terms of, requirements, interests and abilities.

What is claimed is:

1. System wirelessly providing data from a vehicle when challenged via RFid tag systems, comprising:
a windshield having a slot formed along the edge and adapted to accept an RFid tag; and
an RFid tag located within said slot;
wherein said RFid tag is responsive from remote radar challenges by providing an RF transmission of data therefrom.

2. The system of claim 1 wherein said RFid tag is adapted to provide data when challenged by radar, said data including at least one of: vehicle identification numbers (VIN), motor vehicle registration status, motor vehicle inspection status, insurance compliance status, Amber Alert, emission compliance status, speed, toll account information, global positioning system (GPS) data, location status, motor vehicle security/retrieval status.

3. The system of claim 1 including a challenger provided in the form of at least one of a hand held radar unit.

4. The system of claim 3 wherein said RFid tag is adapted to provide data when challenged by radar, said data including at least one of: vehicle identification numbers (VIN), motor vehicle registration status, motor vehicle inspection status, insurance compliance status, Amber Alert, emission compliance status, speed, toll account information, global positioning system (GPS) data, location status, motor vehicle security/retrieval status.

5. The system of claim 1 including a challenger provided in the form of at least one of a radar associated with a tollbooth, or installed in structures associated with roads.

6. The system of claim 5 wherein said RFid tag is adapted to provide data when challenged by radar, said data including at least one of: vehicle identification numbers (VIN), motor vehicle registration status, motor vehicle inspection status, insurance compliance status, Amber Alert, emission compliance status, speed, toll account information, global positioning system (GPS) data, location status, motor vehicle security/retrieval status.

7. The system of claim 1 including a challenger provided in the form of at least one of a radar installed in structures associated with roads including at least one of: bridges, overpasses, intersection signals.

8. The system of claim 7 wherein said RFid tag is adapted to provide data when challenged by radar, said data including at least one of: vehicle identification numbers (VIN), motor vehicle registration status, motor vehicle inspection status, insurance compliance status, Amber Alert, emission compliance status, speed, toll account information, global positioning system (GPS) data, location status, motor vehicle security/retrieval status.

9. A windshield having a slot formed along its edge, said slot adapted to accept an RFid.

10. The windshield of claim 9 further including an RFid tag located within said slot, wherein said RFid tag is responsive from remote radar challenges by providing an RF transmission of data therefrom.

11. The windshield of claim 10, said windshield being installed in a motor vehicle.

12. The windshield of claim 10 wherein said RFid tag is adapted to provide data when challenged by radar, said data including at least one of: vehicle identification numbers (VIN), motor vehicle registration status, motor vehicle inspection status, insurance compliance status, Amber Alert, emission compliance status, speed, toll account information, global positioning system (GPS) data, location status, motor vehicle security/retrieval status.

13. The windshield of claim 11 wherein said RFid tag is adapted to provide data when challenged by radar, said data including at least one of: vehicle identification numbers (VIN), motor vehicle registration status, motor vehicle inspection status, insurance compliance status, Amber Alert, emission compliance status, speed, toll account information, global positioning system (GPS) data, location status, motor vehicle security/retrieval status.

14. System wirelessly providing data from a vehicle when challenged via RFid tag systems, comprising:
a windshield having a slot formed along the edge and adapted to accept an RFid tag; and
an RFid tag located within said slot; and
a challenger provided in the form of at least one of a radar associated with a tollbooth, or installed in structures associated with roads
wherein said RFid tag is responsive from remote radar challenges by said challenger, said RFid tag thereafter providing an RF transmission of data to the challenger.

15. The system of claim 14 wherein said RFid tag is adapted to provide data when challenged by the challenger, said data including at least one of: vehicle identification numbers (VIN), motor vehicle registration status, motor vehicle inspection status, insurance compliance status, Amber Alert, emission compliance status, speed, toll account information, global positioning system (GPS) data, location status, motor vehicle security/retrieval status.
